(19) United States
(12) Patent Application Publication
(10) Pub. No.: US 2011/0028360 A1
(43) Pub. Date: Feb. 3, 2011

(54) ORGANIC CORROSION INHIBITOR PACKAGE FOR ORGANIC ACIDS

(75) Inventor: Alyn Jenkins, Aberdeenshire (GB)

Correspondence Address: OSHA LIANG/MI, TWO HOUSTON CENTER, 909 FANNIN STREET, SUITE 3500, HOUSTON, TX, 77010, US

(73) Assignee: M-I DRILLING FLUIDS U.K. LIMITED, Aberdeenshire (GB)

(21) Appl. No.: 12/935,742

(22) PCT Filed: Mar. 31, 2009
(86) PCT No.: PCT/EP09/53832

§ 371 Date: Sep. 30, 2010

Related U.S. Application Data
(60) Provisional application No. 61/041,852, filed on Apr. 2, 2008.

(51) Int. Cl. C09K 8/60; C09K 8/52; C09K 8/54

(52) U.S. Cl. 507/256

(57) ABSTRACT

An acidizing composition useful for treating a subterranean hydrocarbon producing formation and removing scale from oilfield equipment, the composition including: an acid; water; and an effective amount of a corrosion inhibitor composition including: at least one mercapto-compound; and at least one alkoxylated acetylenic alcohol. Also disclosed are methods for removing scale from metal surfaces and for treating a subterranean hydrocarbon producing formation with such an acidizing composition whereby the corrosive effects of the acidizing composition on metal surfaces in contact therewith are reduced.

### BACKGROUND OF DISCLOSURE

1. Field of the Disclosure

Embodiments disclosed herein relate generally to a method for removing mineral deposits from metal surfaces, in particular, from surfaces of drilling machinery in the oil industry.

2. Background

Subterranean oil recovery operations may involve the injection of an aqueous solution into the oil formation to help move the oil through the formation and to maintain the pressure in the reservoir as fluids are being removed. The injected water, either surface water (lake or river) or seawater (for operations offshore) generally contains soluble salts such as sulfates and carbonates. These salts may be incompatible with the ions already contained in the oil-containing reservoir. The reservoir fluids may contain high concentrations of certain ions that are encountered at much lower levels in normal surface water, such as strontium, barium, zinc and calcium. Partially soluble inorganic salts, such as barium sulfate (or barite) and calcium carbonate, often precipitate from the production water as conditions affecting solubility, such as temperature and pressure, change within the producing well bores and topsides. This is especially prevalent when incompatible waters are encountered such as formation water, seawater, or produced water. When pipes and equipment used in oilfield operations become layered with scale, the encrustation must be removed in a time- and cost-efficient manner.

Additionally, subterranean hydrocarbon-containing formations penetrated by well bores are commonly treated with aqueous acid solutions to stimulate the production of hydrocarbons therefrom. One such treatment known as “acidizing” involves the introduction of an aqueous acid solution into the subterranean formation under pressure so that the acid solution flows through the pore spaces of the formation. The acid solution reacts with acid soluble materials contained in the formation thereby increasing the size of the pore spaces and the permeability of the formation. Another production stimulation treatment known as “fracture-acidizing” involves the formation of one or more fractures in the formation and the introduction of an aqueous acid solution into the fractures to etch the fracture faces whereby flow channels are formed when the fractures close. The aqueous acid solution also enlarges the pore spaces in the fracture faces in the formation.

Some commonly used acids for the removal of scale and for acidizing include hydrochloric acid, hydrofluoric acid, acetic acid, formic acid, citric acid, ethylene diamine tetra acetic acid (“EDTA”), and combinations thereof. Organic acids are often used at high temperatures or when long contact times between acid and pipe are used. In carrying out acidizing and fracture-acidizing treatments in wells and other similar treatments using aqueous acid solutions, the corrosion of metal tubular goods, pumps, and other equipment is often a problem. The expense associated with repairing or replacing corrosion damaged metal tubular goods and equipment can be very high.

In a well treatment utilizing an aqueous acid solution, the corrosion of metal surfaces in tubular goods and equipment results in at least the partial neutralization of the aqueous acid solution before it reacts with acid-soluble materials in the pipes, equipment, or subterranean formation to be treated. Also, the presence of dissolved metals in the aqueous acid solution can bring about the precipitation of insoluble sludge when the aqueous acid solution contacts crude oil, which can severely damage the permeability of the subterranean formation being treated.

Corrosion inhibitors, such as organic thiophosphates, quaternized amines, polyphosphate esters, filming amines, are commonly used to prevent or minimize the corrosion of metal surfaces in tubular goods and equipment. However, many corrosion inhibitors are useful only at selected temperature levels or pH ranges for various brines. Additionally, dilution, temperature changes or any change which affects the pH of the brine can result in loss of corrosion inhibition.

A variety of metal corrosion inhibiting formulations for use in aqueous acid solutions have been developed and used successfully heretofore. Many of such corrosion inhibiting formulations have included quaternary ammonium compounds as essential components, particularly in high temperature applications. However, problems have been associated with the use of quaternary ammonium compounds in that they are generally highly toxic to aquatic organisms. Further, the quaternary ammonium compounds that achieve high degrees of metal corrosion protection at high temperatures are those that have relatively high molecular weights and high degrees of aromaticity. Those quaternary ammonium compounds are not readily available commercially and are very expensive to produce.

Accordingly, there exists a need for corrosion inhibitors for use with organic acids that may be suitable for high temperature operations and are environmentally acceptable.

### SUMMARY OF CLAIMED SUBJECT MATTER

In one aspect, embodiments disclosed herein relate to an acidizing composition useful for treating a subterranean hydrocarbon producing formation and removing scale from oilfield equipment, the composition including: an acid; water; and an effective amount of a corrosion inhibitor composition including: at least one mercapto-compound; and at least one alkoxylated acetylenic alcohol.

In another aspect, embodiments disclosed herein relate to a method of removing scale from metal surfaces with an acidizing composition whereby the corrosive effects of the acidizing composition on metal surfaces in contact therewith are reduced, the method including: contacting the metal surfaces with an aqueous composition including: an acid; water; and an effective amount of a corrosion inhibitor composition including: at least one mercapto-compound; and at least one alkoxylated acetylenic alcohol; and allowing the aqueous solution to dissolve the scale.

In another aspect, embodiments disclosed herein relate to a method of treating a subterranean hydrocarbon producing formation with an acidizing composition whereby the corrosive effects of the acidizing composition on metal surfaces in contact therewith are reduced, including: contacting a subterranean zone with an acidizing composition including: an acid; water; and an effective amount of a corrosion inhibitor composition including: at least one mercapto-compound; and at least one alkoxylated acetylenic alcohol; and recovering said acidizing composition from said subterranean producing formation after said acidizing composition has spent therein.

Other aspects and advantages will be apparent from the following description and the appended claims.

### DETAILED DESCRIPTION

In general, embodiments disclosed herein relate to methods and compositions for carrying out acidizing procedures, fracture acidizing procedures, well bore clean-out procedures, fines removal procedures, and other similar procedures performed in wells with acidizing compositions. In one aspect, embodiments disclosed herein relate to a method for removing mineral deposits or scale from metal surfaces, in particular, from surfaces of drilling machinery in the oil industry. In another aspect, embodiments disclosed herein relate to a method for treating a subterranean hydrocarbon producing formation with an acidizing composition. The removal of mineral deposits and acidizing may be accomplished using an acid composition, which in some embodiments may be suitable for use at high temperatures, such as at least 120° C. To protect metals in the tubular goods and equipment exposed to the acid during the acidizing or scale removal at these high temperatures, the acid solution may include a corrosion inhibitor composition according to embodiments disclosed herein.

A method of dissolving a mineral scale according to an embodiment disclosed herein includes exposing the scale to an aqueous solution that includes an acid and a corrosion inhibitor composition. By exposing the scale to the acid, the acid may cause the scale to dissolve by reaction of the acid with the alkaline earth metal of the scale salt.

A method of treating a subterranean hydrocarbon producing formation with an acidizing composition includes the steps of contacting the subterranean producing formation with an aqueous solution that includes an acid and a corrosion inhibitor composition, and recovering the aqueous solution from the subterranean producing formation after the acid composition has become spent therein.

Aqueous compositions useful for treating subterranean formations and removing scale according to embodiments disclosed herein may include water, an acid, and an effective amount of a corrosion inhibitor composition. In some embodiments, the corrosion inhibited acid compositions may also include at least one of a dispersing agent, an anti-sludging agent, a ferric iron reducer, and a sulfide scavenger, corrosion inhibitor activators, and other useful compounds, such as thioglycolic acid and sodium thiosulfate.

Acids useful in the aqueous compositions disclosed herein may include inorganic acids, organic acids, and mixtures thereof. Inorganic acids useful in acidizing and scale removal processes disclosed herein may include one or more of hydrochloric acid, hydrofluoric acid, fluoboric acid and mixtures thereof. Organic acids useful in acidizing and scale removal processes disclosed herein may include one or more of formic acid, acetic acid, citric acid, lactic acid, and glycolic acid. The aqueous compositions useful in embodiments disclosed herein may include acid at a concentration in the range from about 2 percent to about 35 percent by weight of the aqueous composition; in other embodiments, the acid may be used in a concentration in the range from about 5 percent to about 30 percent by weight of the aqueous composition.

Mineral scale that may be effectively removed from oilfield equipment in embodiments disclosed herein includes oilfield scales, such as, for example, salts of alkaline earth metals or other divalent metals, including sulfates of barium, strontium, radium, and calcium, carbonates of calcium, magnesium, and iron, metal sulfides, iron oxide, and magnesium hydroxide. For example, calcium carbonate may react with formic acid to produce calcium formate, carbon dioxide, and water, where the calcium formate is soluble in the aqueous solution.

The aqueous compositions include a corrosion inhibitor composition to reduce the corrosive effects of the inorganic and organic acids on metal surfaces in contact with the acid and to prevent damage to the subterranean hydrocarbon producing formation. Corrosion inhibitor compositions according to embodiments disclosed herein may include an admixture of at least one mercapto-compound and at least one alkoxylated acetylenic alcohol.

Mercapto-compounds useful in embodiments disclosed herein include chemicals containing at least one mercapto group, and includes, but is not limited to, mercaptoethanol, 1-mercaptopropanediol (thioglycerol), 3-mercapto-2-butanol, 1-mercapto-2-propanol, 3-mercaptopropionic acid, mercaptoacetic acid, mercaptosuccinic acid, 2-mercaptophenol, 2-mercaptobenzoic acid, 3-mercapto-1-propanol, 2-mercaptobezoxazole, 2-mercaptobenzothiazole, 2-mercaptobenzoimidazole, 2-mercaptoimidazole, 2-mercapto-5-methylbenzimidazole, 2-mercaptonicotinic acid, 3-mercaptopropyltrimethoxysilane, and 1-[(2-hydroxyethyl)thio]-3-(octyloxy)-2-propanol. In some embodiments, mercapto-compounds may include mercapto-alcohols having the general formula (HS)ₙ—R—(OH)ₘ, where R is a straight, branched, cyclic or heterocyclic alkylene, arylene, alkylarylene, arylalkylene, or hydrocarbon moiety having from 1 to 30 carbon atoms, and n and m each independently range from 1 to 3. Other mercapto-compounds are disclosed in U.S. Pat. No. 6,365,067, which is incorporated herein by reference.

Alkoxylated acetylenic alcohol compounds useful in embodiments disclosed herein include chemicals represented by the following general formula: HC≡C—R—O—XₙH, where R is an alkyl group, such as CH₂; X is an alkoxylated part, which is either an ethoxylated group, propoxylated group or butoxylated group, or a mixture thereof; n is repeated unit of alkoxylated group and the value is 1-15 in some embodiments and 1-7 in other embodiments. In some embodiments, propoxylated prop-2-yn-1-ol has been found to be particularly effective in reducing the corrosion rate.

As will be shown by the examples below, corrosion rates for metals exposed to acid compositions having only a mercapto-compounds, such as 2-mercaptoethanol, or only a alkoxylated acetylenic alcohol, such as propoxylated prop-2-yn-1-ol, are unacceptable, especially when contacting metals at high temperatures (95° C. or greater). In contrast, it has been found by the present inventor that corrosion rates for metals exposed to acid compositions inhibited with an admixture of mercapto-compounds and alkoxylated acetylenic alcohols, together, are acceptable, even when contacting metals at high temperatures. Because neither of these components alone significantly reduces corrosion rates, the significant decrease in corrosion rates when mercapto-compounds, such as 2-mercaptoethanol, and alkoxylated acetylenic alcohols, such as propoxylated prop-2-yn-1-ol are used together was a surprising result, and the synergy resulting from the combination unexpected.

The aqueous compositions useful in embodiments disclosed herein may include an effective amount of a corrosion inhibitor composition. For example, aqueous corrosion inhibitor compositions according to embodiments disclosed herein may be used in an amount in the range from about 0.25 percent to about 15 percent by weight of the aqueous composition. Effective amounts may be determined by those skilled in the art, and may be a function of the contacted metal, the formation being treated, contact times, contact temperature, and the acid(s) used in the aqueous composition, among other factors known to those skilled in the art. The corrosion inhibitor composition may include one or more mercapto-compounds and one or more alkoxylated acetylenic alcohols, where a ratio of the mercapto-compound to the alkoxylated acetylenic alcohol may range from about 0.1:1 to about 1:1 in some embodiments; from about 0.25:1 to about 0.9:1 in other embodiments; and from about 0.5:1 to about 0.8:1 in yet other embodiments.

In some embodiments, the aqueous compositions may include one or more alkoxylated acetylenic alcohols in an amount up to about 10 percent by weight of the aqueous composition; up to about 7.5 percent by weight of the aqueous composition in other embodiments, up to about 5 percent by weight of the aqueous composition in other embodiments, up to about 2.5 percent by weight of the aqueous composition in other embodiments, from about 1 percent to about 3 percent by weight in other embodiments; from about 1.25 percent to about 2.75 percent by weight in other embodiments; from about 1.5 percent to about 2.5 percent by weight in other embodiments; and from about 1.75 percent to about 2.25 percent by weight in other embodiments.

In some embodiments, the aqueous compositions may include one or more mercapto-compounds in an amount up to about 5 percent by weight of the aqueous composition; up to about 2.5 percent by weight of the aqueous composition in other embodiments, up to about 1.5 percent by weight of the aqueous composition in other embodiments, up to about 1 percent by weight of the aqueous composition in other embodiments, from about 0.1 percent to about 2 percent by weight in other embodiments; from about 0.25 percent to about 1.5 percent by weight in other embodiments; from about 0.5 percent to about 1 percent by weight in other embodiments; and from about 0.6 percent to about 0.9 percent by weight in other embodiments.

In some embodiments, the aqueous compositions disclosed herein, useful for acidizing, scale removal and other procedures, may include from about 10 percent to about 40 percent acid, from greater than zero to about 10 percent alkoxylated acetylenic alcohol, from greater than zero to about 5 percent mercapto-compounds, and the balance water and other optional components as mentioned above, based on the total weight of the aqueous composition.

In a family of embodiments, the aqueous compositions disclosed herein, useful for acidizing, scale removal and other procedures, may include from about 10 percent to about 40 percent formic acid, from greater than zero to about 10 percent alkoxylated acetylenic alcohol, from greater than zero to about 5 percent mercapto-compound, and the balance water and other optional components as mentioned above, based on the total weight of the aqueous composition.

In a more specific family of embodiments, the aqueous compositions disclosed herein, useful for acidizing, scale removal and other procedures, may include from about 10 percent to about 30 percent formic acid, from about 0.1 percent to about 10 percent propoxylated prop-2-yn-1-ol, from about 0.1 percent to about 10 percent 2-mercaptoethanol, and the balance water and other optional components as mentioned above, based on the total weight of the aqueous composition. In some embodiments, the aqueous solution may also include citric acid in an amount up to about 2 percent by weight of the aqueous composition, from about 0.75 to about 1.25 percent by weight of the aqueous composition in other embodiments; and from about 0.9 to about 1.1 percent by weight of the aqueous composition in yet other embodiments.

In yet other embodiments, the aforementioned aqueous compositions may be diluted prior to use. For example, an aqueous composition including about 30 percent formic acid and other components, as described in the previous paragraph, may be diluted with water prior to use. In some embodiments, the aqueous compositions described herein may be diluted with water in a ratio of up to 5 parts water per 1 part aqueous solution. Dilution may be desired, for example, where an aqueous solution is supplied in the form of a concentrate.

In some embodiments, aqueous compositions useful for acidizing, scale removal and other procedures, as disclosed herein, may be useful for processes requiring the aqueous compositions to contact metals for extended periods of time, such as 8, 16, or 24 hours, and at elevated temperatures, such as greater than about 95° C., greater than about 120° C., greater than about 130° C., greater than about 160° C., or greater than about 185° C. in various embodiments. For example, aqueous compositions disclosed herein may be used when contacting iron-based alloys including 13 Cr steel, carbon steels, stainless steel, duplex steels, super duplex, and other metals commonly found in oil production at the aforementioned temperatures and contact times.

Aqueous compositions disclosed herein, useful for acidizing, scale removal and other procedures, may have a corrosion rate, as measured using the procedures outlined in the Examples below, of less than 100 mpy (mass lost per year, in grams, as described further in the Examples) in some embodiments. In other embodiments, aqueous compositions disclosed herein may have a corrosion rate of less than 75 mpy; less than 50 mpy in other embodiments; less than 40 mpy in other embodiments; and less than 30 mpy in yet other embodiments. Various embodiments of the aqueous compositions disclosed herein may fall within any of the above ranges, and may vary based upon exposure time, metal type, and temperature, among other variables.

Aqueous compositions disclosed herein, useful for acidizing, scale removal and other procedures, may have a measured weight loss value, as measured using the procedures outlined in the Examples below, of less than 0.05 lbs/ft² (representative of weight lost per initial exposed area of a coupon, as described further in the Examples) in some embodiments. In other embodiments, aqueous compositions disclosed herein may have a corrosion rate of less than 0.04 lbs/ft²; less than 0.03 lbs/ft² in other embodiments; less than 0.02 lbs/ft² in other embodiments; less than 0.01 lbs/ft² in other embodiments; and less than 0.005 lbs/ft² in yet other embodiments. Various embodiments of the aqueous compositions disclosed herein may fall within any of the above ranges, and may vary based upon exposure time, metal type, and temperature, among other variables.

### Examples

Various corrosion inhibited acidizing compositions, according to embodiments disclosed herein, were tested for corrosivity. The test methods used and the test results are as follows. Although acid compositions are referred to during the examples as “scale dissolver,” it should be understood that the compositions are also suitable for acidizing, fracture acidizing, and other treatment procedures described above.

Corrosivity

Test Method: Prior to use, metal coupons (13 Cr steel, C1018 steel, 316 stainless steel, and SAF 2507 (duplex)) were rinsed with acetone, allowed to dry, and weighed to four decimal places. The surface area of the coupons was also determined. Coupons were placed in a TEFLON lined mud bomb with the appropriate amount of scale dissolver. The volume of scale dissolver added was determined using the following equation: Volume of scale dissolver (ml)=surface area of coupon (cm²) times 6.5. The mud bombs were then sealed and placed in an oven at the test temperature for the specified test period (8 or 24 hours). The coupons were then removed, cleaned, rinsed with acetone, dried, and re-weighed. The corrosion rate was calculated using the following equation:

Corrosion Rate (mass per year)=W×3.45×10⁶/(A×T×D)

where W is the mass loss in grams, A is the initial exposed area of the coupon in cm², T is the exposure time in hours, and D is the density of the metal coupon in g/cm³.

For scale dissolvers, it is also industry standard to express the weight loss in lb/ft², and are typically required to have a weight loss of less than 0.05 lb/ft² to be acceptable for use. Weight loss is calculated according to the following equation:

Weight loss (lb/ft²)=(W/A)/0.4882

where W and A are as defined above.

Samples and Results: Aqueous compositions including approximately 22 percent formic acid, water, and approximately 1 percent of only one of propoxylated prop-2-yn-1-ol and 2-mercaptoethanol (Comparative Samples 1 and 2, respectively) were contacted with 13Cr stainless steel at 95° C. according to the procedures outlined above. The Comparative Samples were tested using a neat composition. The test results are summarized in Table 1 below.

TABLE 1

| | | T | Time | | | Corr Rate |
|---|---|---|---|---|---|---|
| Product | Additive | ° C. | (hrs) | Metal | Conc | mm/yr |
| Comparative | propoxylated | 95 | 24 | 13Cr | Neat | 288 |
| Sample 1 | prop-2- | | | | | |
| | yn-1-ol | | | | | |
| Comparative | 2-mercapto- | 95 | 24 | 13Cr | 50% | 200 |
| Sample 2 | ethanol | | | | | |

As shown in Table 1 above, use of 2-mercaptoethanol or propoxylated prop-2-yn-1-ol by themselves did not result in acceptable corrosion rates. In contrast, it has been found, as described below, that a combination of 2-mercaptoethanol and propoxylated prop-2-yn-1-ol may result in acceptable corrosion rates over extended periods of time and at elevated temperatures.

An aqueous composition according to embodiments disclosed herein (referred to in Table 1 as “Sample”) and including approximately 22 percent formic acid, 73.89 percent water, 1 percent citric acid, 2 percent propoxylated prop-2-yn-1-ol, 0.75 percent 2-mercaptoethanol, and 0.46 percent lithium chloride was contacted with various metals according to the procedure outlined above. The Sample was tested using the neat composition and the composition diluted with water at a 1:1 weight ratio (50% concentration). The test results are summarized in Table 2 below.

TABLE 2

| Prod- | T | Time | | Concen- | Corrosion Rate | | Wt loss |
|---|---|---|---|---|---|---|---|
| uct | ° C. | (hrs) | Metal | tration | mpy | mm/yr | lbs/ft² |
| Sample | 95 | 24 | 13Cr | Neat | 73 | 1.84 | 0.0076 |
| Sample | 95 | 24 | 13Cr | 50% | 33 | 0.83 | 0.0036 |
| Sample | 95 | 24 | C1018 | Neat | 46 | 1.16 | 0.0051 |
| Sample | 95 | 24 | C1018 | 50% | 48 | 1.21 | 0.0053 |
| Sample | 95 | 24 | 316 | Neat | 34 | 0.87 | 0.0039 |
| Sample | 95 | 24 | 316 | 50% | 37 | 0.94 | 0.0042 |
| Sample | 130 | 24 | 13Cr | Neat | 212 | 5.38 | 0.0232 |
| Sample | 130 | 24 | 13Cr | 50% | 132 | 3.36 | 0.0145 |
| Sample | 130 | 24 | C1018 | Neat | 694 | 17.60 | 0.0712 |
| Sample | 130 | 24 | C1018 | 50% | 703 | 17.85 | 0.0262 |
| Sample | 130 | 8 | C1018 | Neat | 703 | 17.85 | 0.0262 |
| Sample | 130 | 8 | C1018 | 50% | 492 | 12.48 | 0.0183 |
| Sample | 130 | 24 | 316 | Neat | 44 | 1.11 | 0.0046 |
| Sample | 130 | 24 | 316 | 50% | 12 | 0.31 | 0.0013 |
| Sample | 130 | 24 | Duplex | Neat | 15.17 | 0.38 | 0.0017 |
| Sample | 130 | 24 | Duplex | 50% | 0.40 | 0.01 | 0.0000 |
| Sample | 160 | 24 | 13Cr | Neat | 499 | 12.67 | 0.0548 |
| Sample | 160 | 24 | 13Cr | 50% | 341 | 8.66 | 0.0374 |
| Sample | 160 | 8 | 13Cr | Neat | 556 | 14.10 | 0.0203 |
| Sample | 160 | 8 | 13Cr | 50% | 192 | 4.86 | 0.0070 |
| Sample | 160 | 24 | 316 | Neat | 134 | 3.40 | 0.0153 |
| Sample | 160 | 24 | 316 | 50% | 119 | 3.03 | 0.0136 |
| Sample | 160 | 8 | 316 | Neat | 60 | 1.52 | 0.0023 |
| Sample | 160 | 8 | 316 | 50% | 34 | 0.86 | 0.0013 |
| Sample | 160 | 24 | Duplex | Neat | 115 | 2.91 | 0.0127 |
| Sample | 160 | 24 | Duplex | 50% | 8 | 0.21 | 0.0009 |
| Sample | 160 | 8 | Duplex | Neat | 482 | 12.22 | 0.0178 |
| Sample | 160 | 8 | Duplex | 50% | 15 | 0.39 | 0.0006 |
| Sample | 185 | 8 | 13Cr | Neat | 24988 | 634.21 | 0.9137 |
| Sample | 185 | 8 | 13Cr | 50% | 9995 | 253.67 | 0.3654 |
| Sample | 185 | 8 | 316 | Neat | 600 | 15.22 | 0.0683 |
| Sample | 185 | 8 | 316 | 50% | 124 | 3.13 | 0.0141 |
| Sample | 185 | 8 | Duplex | Neat | 880 | 22.35 | 0.0326 |
| Sample | 185 | 8 | Duplex | 50% | 453 | 11.50 | 0.0168 |

Generally to be acceptable for use, the coupon weight loss must be less than the industry standard acceptable limit of 0.05 lbs/ft². The corrosion testing was performed for durations longer than those typically used for scale dissolvers in the field. However, long duration tests may help fully assess the corrosivity of the scale dissolver should problems arise in the field following application resulting in longer contact times. The above results indicate that scale dissolver compositions according to embodiments disclosed herein, including propoxylated prop-2-yn-1-ol and 2-mercaptoethanol as an inhibitor composition, may be suitable for use with 13 Cr steel, C1018 steel, 316 stainless steel, and SAF 2507 (duplex) for use up to 160° C. For temperatures of up to 130° C., contact times of less than 8 hours may be preferred. For temperatures greater than 130° C., contact times of less than 8 hours may be preferred so as to avoid excessive corrosion. Scale dissolvers according to embodiments disclosed herein may also be useful for removing scale from other metals.

Ecotoxicology

In addition to corrosion requirements, discussed above, use of various drilling fluids, including acidizing compositions, is often regulated based upon the ecotoxicology of the composition. For example, raw materials often have to meet various biodegradation, toxicity, and bioaccumulation requirements.

Propoxylated prop-2-yn-1-ol, as a raw material for the corrosion inhibitor compositions disclosed herein, was tested for ecotoxicology. Biodegradation was measured according to OECD 301B. EC50 Toxicity was measured according to ISO/DP 10253. Bioaccumulation log Pow was measured according to OECD 117. The test results are summarized in Table 3, and it is noted that the results indicate that propoxylated prop-2-yn-1-ol would be classified as a “green” product, acceptable for use in virtually any regulated territory.

TABLE 3

| | | | Bioaccumulation |
|---|---|---|---|
| Raw Material | Biodegradation | Toxicity | Log Pow |
| Propoxylated | 100% (OECD 301B) | 100 mg/l | 2 |
| prop-2-yn-1-ol | | | |

As described above, aqueous compositions disclosed herein, useful for scale dissolution, acidizing, fracture acidizing, and other processes, are both environmentally friendly, having a low ecotoxicology, and meet or exceed industry standards for corrosivity and weight loss, even when used at elevated temperatures. Advantageously, embodiments disclosed herein may provide for a process by which mineral scale can be removed from oilfield equipment and the dissolving solution may be reclaimed without significant damage to metals and elastomers used in the equipment. Additionally, embodiments disclosed herein meet various environmental regulations regarding ecotoxicology.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A composition useful for treating a subterranean hydrocarbon producing formation and removing scale from oilfield equipment, the composition comprising:
an acid;
water; and
an effective amount of a corrosion inhibitor composition comprising:
at least one mercapto-compound; and
at least one alkoxylated acetylenic alcohol.

2. The composition of claim 1, wherein the mercapto-compound comprises 2-mercaptoethanol.

3. The composition of claim 1, wherein the alkoxylated acetylenic alcohol comprises propylated prop-2-yn-1-ol.

4. The composition of claim 1, wherein the mercapto-compound comprises 2-mercaptoethanol and wherein the alkoxylated acetylenic alcohol comprises propylated prop-2-yn-1-ol

5. The composition of claim 1, wherein the acid comprises at least one of an inorganic and an organic acid.

6. The composition of claim 1, wherein the organic acid comprises at least one of formic acid, acetic acid, citric acid, lactic acid, glycolic acid, and mixtures thereof.

7. The composition of claim 1, wherein the inorganic acid comprises at least one of hydrochloric acid, hydrofluoric acid, fluoboric acid and mixture thereof.

8. The composition of claim 1, further comprising at least one of a dispersing agent, an anti-sludging agent, a ferric iron reducer, and a sulfide scavenger.

9. The composition of claim 1, wherein the composition comprises up to about 10 percent by weight of the alkoxylated acetylenic alcohol.

10. The composition of claim 1, wherein the composition comprises up to about 5 percent by weight of the mercapto-compound.

11. The composition of claim 1, wherein the composition comprises:
from about 10 to about 40 weight percent formic acid; and
from about 0.1 to about 10 weight percent propoxylated prop-2-yn-1-ol;
from about 0.1 to about 10 weight percent 2-mercaptoethanol; and
from about 45 to about 90 weight percent water.

12. The composition of claim 8, further comprising up to about 2 weight percent citric acid.

13. A method of removing scale from metal surfaces with an acidizing composition whereby the corrosive effects of the acidizing composition on metal surfaces in contact therewith are reduced, the method comprising:
contacting the metal surfaces with an aqueous composition comprising:
an acid;
water; and
an effective amount of a corrosion inhibitor composition comprising:
at least one mercapto-compound; and
at least one alkoxylated acetylenic alcohol; and
allowing the aqueous solution to dissolve the scale.

14. The method of claim 13, further comprising recovering the aqueous composition after a select contact time.

15. The method of claim 13, wherein the acid comprises at least one of an inorganic and an organic acid.

16. The method of claim 13, wherein the organic acid comprises at least one of formic acid, acetic acid, citric acid, lactic acid, glycolic acid, and mixtures thereof.

17. The method of claim 13, wherein the inorganic acid comprises at least one of hydrochloric acid, hydrofluoric acid, fluoboric acid and mixture thereof.

18. The method of claim 13, further comprising at least one of a dispersing agent, an anti-sludging agent, a ferric iron reducer, and a sulfide scavenger.

19. The method of claim 13, wherein the composition comprises up to about 10 percent by weight of the alkoxylated acetylenic alcohol.

20. The method of claim 13, wherein the composition comprises up to about 5 percent by weight of the mercapto-compound.

21. The method of claim 13, wherein the composition comprises:
from about 10 to about 40 weight percent formic acid; and
from about 0.1 to about 10 weight percent propoxylated prop-2-yn-1-ol;
from about 0.1 to about 10 weight percent 2-mercaptoethanol; and
from about 45 to about 90 weight percent water.

22. The method of claim 21, further comprising up to about 2 weight percent citric acid.

23. A method of treating a subterranean hydrocarbon producing formation with an acidizing composition whereby the corrosive effects of the acidizing composition on metal surfaces in contact therewith are reduced, comprising:
contacting a subterranean zone with an acidizing composition comprising:
an acid;
water; and
an effective amount of a corrosion inhibitor composition comprising:
at least one mercapto-compound; and
at least one alkoxylated acetylenic alcohol; and
recovering said acidizing composition from said subterranean producing formation after said acidizing composition has spent therein.

24. The method of claim 23, wherein the acid comprises at least one of an inorganic and an organic acid.

25. The method of claim 23, wherein the organic acid comprises at least one of formic acid, acetic acid, citric acid, lactic acid, thioglycolic acid, glycolic acid, and mixtures thereof.

26. The method of claim 23, wherein the inorganic acid comprises at least one of hydrochloric acid, hydrofluoric acid, fluoboric acid and mixture thereof.

27. The method of claim 23, further comprising at least one of a dispersing agent, an anti-sludging agent, a ferric iron reducer, and a sulfide scavenger.

28. The method of claim 23, wherein the composition comprises up to about 10 percent by weight of the alkoxylated acetylenic alcohol.

29. The method of claim 23, wherein the composition comprises up to about 5 percent by weight of the mercapto-compound.

30. The method of claim 23, wherein the composition comprises:
from about 10 to about 40 weight percent formic acid; and
from about 0.1 to about 10 weight percent propoxylated prop-2-yn-1-ol;
from about 0.1 to about 10 weight percent 2-mercaptoethanol; and
from about 45 to about 90 weight percent water.

31. The method of claim 30, further comprising up to about 2 weight percent citric acid.
